(19) United States
(12) Patent Application Publication
(10) Pub. No.: US 2008/0050561 A1
(43) Pub. Date: Feb. 28, 2008

(54) Micromechanical Component With Active Elements and Method Producing a Component of This Type

(76) Inventors: Helene Joisten, Grenoble (FR); Robert Cuchet, Monestier de Percy (FR); Marcel Audoin, Noyarey (FR); Gerard Barrois, Le Fontanil (FR)

Correspondence Address: BRINKS HOFER GILSON & LIONE, P.O. BOX 10395, CHICAGO, IL, 60610, US

(21) Appl. No.: 11/813,626

(22) PCT Filed: Jan. 10, 2006
(86) PCT No.: PCT/FR06/00045

§ 371 Date: Aug. 29, 2007

(30) Foreign Application Priority Data
Jan. 11, 2005 (FR) 0500274

(51) Int. Cl. B32B 3/00; B44C 1/22

(52) U.S. Cl. 428/156; 216/22

(57) ABSTRACT

The invention relates to a method for producing a component with a first face of a plate-shaped structure involving the following steps: engraving a second face of the structure, which is opposite the first face, on a portion of its surface in order to define an area of reduced thickness, and; inclining the area of reduced thickness with regard to said structure. A component of this type has a recess between the plate-shaped structure and the inclined area of reduced thickness. The inclined area can support active elements that function according to a direction defined by the inclination.

### PRIORITY CLAIM

This application is a U.S. nationalization of PCT Application No. PCT/2006/000045, filed Jan. 10, 2006, and claims priority to French Patent Application No. 0500274, filed Jan. 11, 2005.

### TECHNICAL FIELD

The invention concerns a component, in particular with active elements, and a method for producing a component of this type. It may in particular be a question of a microelectronic component.

### BACKGROUND

Components are frequently used having a portion consisting of at least one plate-shaped structure one face whereof carries active elements.

In the context of microelectronics, for example, a substrate can carry electronic circuits such as magnetic field sensors.

It is sometimes wished to dispose the active elements in a plane that is inclined, or even perpendicular, to the plane defined by the plate.

This is the case in particular if it is required to measure a magnetic field in three dimensions as described in U.S. Pat. No. 5,446,307, for example.

According to that document, magnetic sensors are placed so that each measures the component of the magnetic field perpendicular to one of the inclined faces of a pyramidal structure, which is a simple way to provide access to the three components of the magnetic field.

The front face etching technology used to obtain the pyramidal structure limits the height that can be envisaged for the structure to a few micrometers, however, and makes this solution inapplicable to magnetic sensors with larger dimensions (for example of the order of 1000 μm) the use whereof on the inclined faces of the structure would lead to much too shallow an inclination of the latter (less than 1% inclination) to be able to measure the magnetic field effectively in a direction other than perpendicular to the substrate.

### SUMMARY

The invention therefore aims in particular to propose an alternative solution for obtaining, starting from a plate-shaped structure, a plane inclined to the remainder of that structure. That inclined plane can advantageously comprise, before or after inclination, a magnetic sensor in the context of microelectronics or any other microelectronic device.

The invention therefore proposes a method of producing a component comprising a first face of a plate-shaped structure, characterized in that it includes the following steps:
etching a second face of the structure, opposite the first face, over a portion of its surface in order to define a reduced thickness area;
inclining the reduced thickness area relative to said structure, the component comprising at least one active element in the inclined area.

An inclined surface can therefore be obtained using an etching operation that is relatively simple to implement. The inclination of the reduced thickness area also enables the active element to function in a direction (defined by the inclination) other than that enabled by the plate-shaped structure, for example, differing from the latter by an angle from 10° to 90°.

The active element is present on the first face before inclination of the future reduced thickness area, for example. Alternatively, after the inclination step, an active element can be transferred, for example glued, to the inclined area.

The inclination step can be preceded by a step of forming a hinge over a first portion of the circumference of the reduced thickness area and/or a step of etching a cutting path over a second portion of the circumference of the reduced thickness area.

These steps in particular delimit precisely the area to be inclined.

The step of forming a hinge is carried out, for example, by transferring, by means of the step of etching of the second face, a notch formed on the second face. This particular solution is particularly well adapted to the invention.

In the example described in detail hereinafter, the active element is a magnetic field sensor, for example of the microfluxgate type. When it is present on the inclined face produced in accordance with the invention, such a sensor can measure a component of the magnetic field orthogonal to the plate.

That active element will advantageously have been produced on the “plane” plate-shaped structure by standard microelectronics techniques (etching, deposition, etc.) before inclination.

For example, each of the active elements is disposed, before or after inclination, partly on the reduced thickness area and partly on a portion of the structure that is not subjected to the etching of the second face.

There are obtained in this way active elements directed in directions that provide access to a magnitude in the three dimensions of space.

According to one implementation possibility, the method comprises a step of transferring the structure onto a substrate that can be produced before or after the inclination step.

The second face of the structure can then be placed in contact with the substrate and one end of the reduced thickness area can come into contact with the substrate after the inclination step, in order to define a new stable position for that area.

The invention also proposes a component comprising an area inclined relative to a plate-shaped structure, characterized in that the inclined area has a reduced thickness relative to said structure and is connected to the structure by a hinge and in that the component has a recess between the inclined area and said structure. An active element is disposed on a first face of the inclined area.

The inclined area is connected to the plate-shaped structure by a hinge that comprises a portion with a thickness less than the thickness of the inclined area, for example.

Features and advantages of the method explained hereinabove apply equally by analogy to the component just referred to.

In particular, the second face of the plate-shaped structure can be fastened to a substrate. The end of the inclined area opposite the plate-shaped structure is then situated in contact with the substrate, for example.

There may equally be provided in this case means for holding the inclined area relative to the substrate. For example, these holding means comprise a glue or a resin that encompasses the area of contact of the substrate and the inclined area, and/or using electrostatic or magnetic forces.

If the active element is a magnetic field sensor, the latter can thus measure a field in a direction parallel to the inclined area and at a non-zero angle to the plate-shaped structure. This sensor provides access to the component of the magnetic field orthogonal to the plate-shaped structure.

### BRIEF DESCRIPTION OF THE DRAWINGS

Other features and advantages of the invention will become more apparent in the light of the following description, given with reference to the appended drawings, in which:

FIGS. 1 to 3 illustrate a method of producing a component according to a first embodiment of the invention;

FIG. 4 illustrates diagrammatically the essential elements of the component during its production as seen from above.

### DETAILED DESCRIPTION

At the beginning of its production process, the component essentially comprises a plate of essentially constant thickness (for example of the order of 500 μm thick), made in silicon, for example, and a layer of insulation 4, 5 in which active elements are encapsulated, here electronic circuits, and in particular magnetic field sensors 6, 8, 10, 12 such as those used in microelectronics, generally called “microfluxgates”.

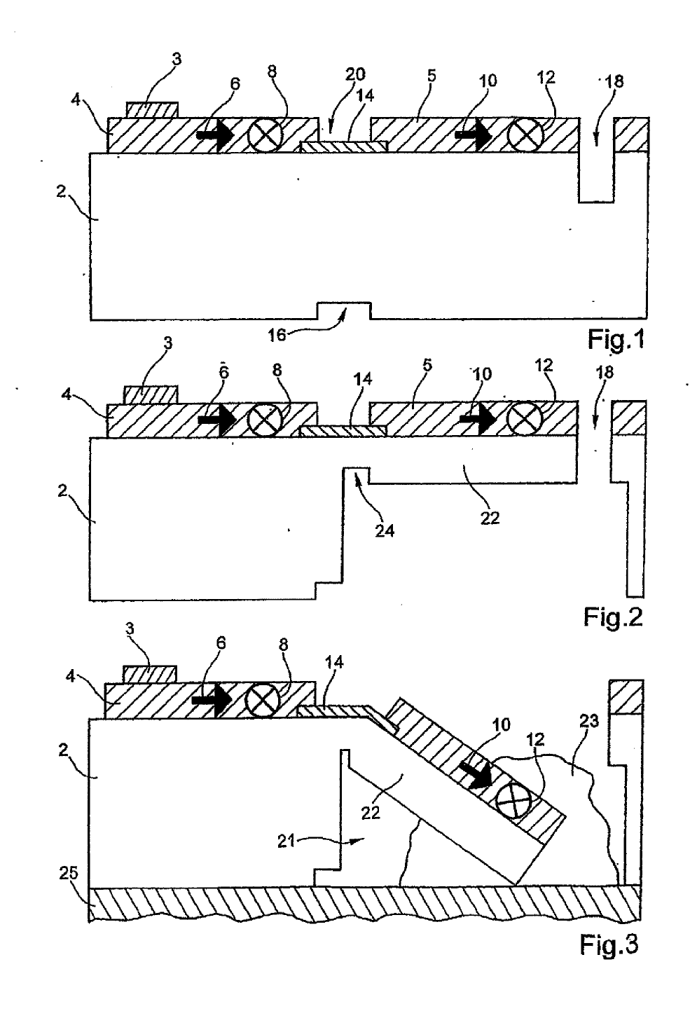

The sensors are divided into two groups: first sensors 6, 8 in a first portion 4 of the layer of insulation (the portion situated on the left in FIG. 1) and second sensors 10, 12 in a second portion 5 of the layer of insulation (the portion situated on the right in FIG. 1).

In each group, the two sensors are disposed to measure mutually orthogonal components X, Y of the magnetic field.

For other applications, there could be only one sensor for one or both groups, or even a single group of one or more sensors intended to be inclined.

At this stage of the method, all the sensors are therefore placed so that their measurement direction is a horizontal component of the magnetic field (i.e. parallel to the plate 2, in the plane formed by the directions X and Y). For example, they have been fabricated from the silicon plate 2 using standard microelectronics techniques, for example collectively.

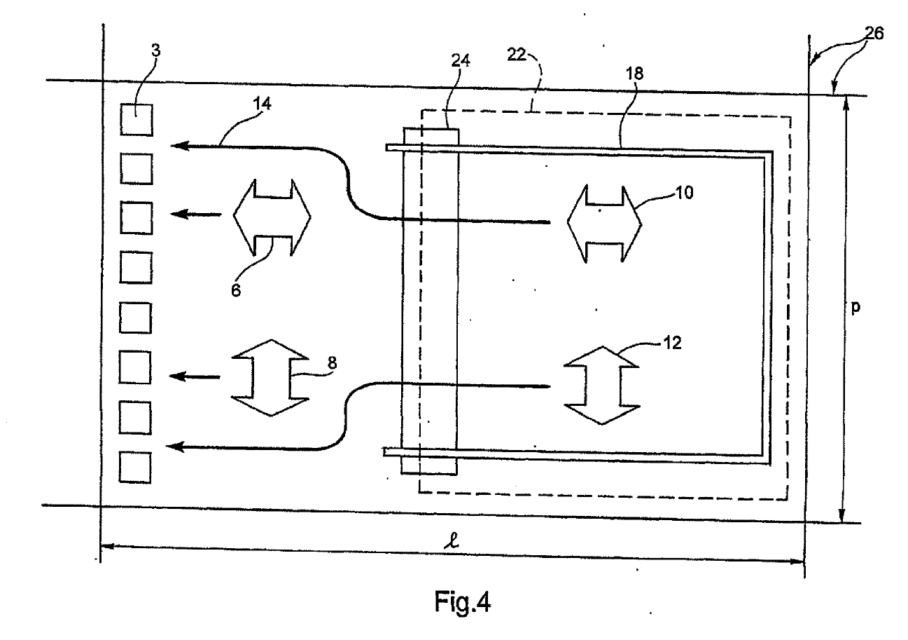

Connection contacts are deposited on the upper face of the layer 4, 5 of insulation (the face opposite the silicon plate 2). These contacts 3 are connected to the various sensors 6, 8, 10, 12 as shown diagrammatically in FIG. 4 and described in detail later.

In an optional step of preparation of the faces of the component, the layer 4, 5 of insulation (for example SiO₂ or a polymer, for example of BCB type) can be eliminated over a portion 20 of reduced width (for example of the order of 100 μm wide) situated between the first sensors 6, 8 and the second sensors 10, 12, whilst preserving the integrity in this reduced width portion 20 of the tracks 14 connecting the sensors 10, 12 to the corresponding contacts 3. These tracks 14 (only a portion of which is shown diagrammatically in the figures) are made in copper, for example.

This step of eliminating the layer of insulation is not necessary if the insulation is sufficiently flexible over this reduced width portion, because of the material chosen and/or its thickness, to be integrated into the future hinge.

A notch 16 is formed (for example also by etching) in the lower face of the plate 2 (i.e. in the face opposite the upper face carrying the layer 4 of insulative material). The notch 16 is also produced on a reduced width portion in line with the reduced width portion 20 from which the layer 4 of insulation has been eliminated. The notch extends with a depth of the order of 100 μm into the thickness of the plate 2, for example.

A cutting path 18 is also etched that passes through the layer 5 of insulation and attacks the plate 2 over a relatively small (although not negligible) portion of the thickness, for example to a depth of 150 μm. The cutting path 18 extends over a substantial portion of the circumference of the second portion 5 of the layer of insulation as defined above.

There is then obtained for the component in the course of production the structure represented in FIG. 1.

It may further be noted that the insulative material layer 4, 5 is then physically divided into two layer portions of which one (first portion, reference number 4) comprises the first sensors 6, 8 and the other (second portion, reference number 5) comprises the second sensors 10, 12.

The second portion 5 of the insulative material layer is thus delimited on the one hand by the eliminated reduced width portion 20 and on the other hand by the cavity 18.

There is then etched a region of the lower face (or rear face) of the plate 2 that extends laterally of the eliminated insulative portion 20 of reduced width to the cavity 18, which corresponds to a width of the order of 1 mm (i.e. 1000 μm), for example. This etching is effected over a substantial portion of the thickness of the plate 2 so as to leave in the region previously defined only a reduced thickness of the plate 2, as shown by the reference number 22 in FIG. 2.

Such a reduced thickness has a value of the order of 150 μm, for example.

Generally speaking, the etching depth must be sufficient to enable the inclination of the reduced thickness region 22 (in the space left free by the etching) as described hereinafter at the same time as retaining sufficient rigidity of this region to carry the sensors (except at the level of the hinge referred to hereinafter).

The etching employed is anisotropic etching, for example, which enables the region previously defined to be attacked accurately, for example by RIE type etching (reactive ion etching).

Moreover, an etching process is preferably chosen that eliminates a uniform depth (here 350 μm) of the material of the plate 2, which enables transfer of the notch 16 formed in the initial lower face of the plate 2 in the region 22 of reduced thickness to produce a hinge 24 whose thickness in the example shown is thus limited to 50 μm.

Moreover, the etching depth is such that the thickness of the plate is reduced to nothing in the cutting path 18, enabling separation of the two plate portions on either side of the cutting part 18.

The structure obtained in this way is shown in FIG. 2.

Thus the reduced thickness region 22 is separated from the remainder of the plate 2 by the cutting path 18 over a substantial portion of its circumference (here three sides of a rectangle) and connected to the remainder of the plate 2 by the hinge 24 over the residual portion of its circumference (here the fourth side of the rectangle).

As an alternative, it is possible to carry out the deep etching on the rear face before the etching of the cutting path 18 or a portion thereof.

It is equally possible for there to remain after etching of the rear face a small thickness of material along the cutting path, which thickness can be broken afterwards, for example by mechanical action or further etching of the cutting path, at the required time of inclination, or by magnetic or electrostatic loading.

The structure can then be transferred onto a substrate 25, for example a second plate of silicon with an interposed glue 23 (or any other material, for example a resin, which can be deposited collectively by standard means used in microelectronics) to fill at least partly the portion left free by the etching of the rear face of the plate 2. This glue holds the reduced thickness portion in an inclined position with no possibility of subsequent movement. Other means can be provided to assure this holding, provided that they do not interfere with the operation of the sensors or other components present on the device. Thus for certain applications holding by means of electrostatic and/or magnetic forces may be envisaged, for example.

Thanks to the hinge 24 produced as mentioned hereinabove, it is easy to obtain an inclination of the reduced thickness portion 22 (which carries the second portion 5 of the layer of insulative material and the second sensors 10, 12). This inclination can be brought about by mechanical and/or electrostatic and/or magnetic loading or take place automatically at the time of rear face etching or etching the cutting path 18. It can take place before or after the transfer step.

There is obtained in this way a structure of the component which, as shown in FIG. 3, comprises in a first portion the plate 2 with its original thickness and the first sensors 6, 8 on the upper face and in a second portion the reduced thickness region 22 the upper face whereof, which carries the second sensors 10, 12, is inclined relative to the upper face of the first portion of the plate 2.

In the example described here, an inclination of the order of 20° is obtained, but other dimension values could naturally be used to obtain other inclination values (generally from 10° to 90°), as a function of the mechanical properties of the materials) in the area of the hinge (dimensions, flexibility, etc.). An inclination of 90° can therefore be achieved with an appropriate hinge.

The method used leaves a recess 21 between the first portion of the plate 2 of original thickness and the inclined reduced thickness portion 22.

The second sensor 10, which was originally situated in a horizontal plane (i.e. essentially parallel to the upper face of the plate 2) is therefore at this stage inclined to the horizontal and therefore no longer measures only a component in the direction X, but a combination of the components in the directions X and Z of the magnetic field, from which it is easy to deduce the component in the direction Z (i.e. perpendicular to the plane of the plate 2) since the component in the direction X is given by the horizontal first sensor 6.

Note further that using a relatively flexible material (for example, copper) to form electrical tracks avoids the risk of these tracks breaking when inclining the reduced thickness portion 22 relative to the plate 2.

The inclination of the upper face of the reduced thickness portion 22 relative to the plate 2 is therefore obtained by relatively simple techniques employing etching with constant depth for particular regions. This solution is therefore particularly beneficial for fields in which the definition of the structures must be limited to simple operations, like microelectronics (the example described here), micromechanics or integrated optics.

In the example that has just been described, the sensors 8, 12 are both adapted to measure the component of the magnetic field in the direction Y. Alternatively, only one of these two sensors 8, 12 could be used and one of the groups of sensors defined hereinabove could then be limited to one sensor.

FIG. 4 represents the component diagrammatically during its production process, specifically the step represented in FIG. 2.

The component has a rectangular shape and extends in the direction X with a dimension 1 of the order of 2.5 mm (which corresponds to the width of the whole plate 2, including the reduced thickness portion 22, in FIGS. 1 to 3) and in the direction Y with a dimension p of the order of 1.5 mm.

Note that only one component is represented in FIG. 4, but that a plurality of components can be produced at the substrate scale in the course of the same method and then cut along the cutting lines 26 shown in FIG. 4.

FIG. 4 represents diagrammatically the first sensors 6, 8 disposed in the first portion 4 of the layer of insulation, i.e., in the portion of the plate 2 in which the original thickness is retained. The second sensors 10, 12 are also represented diagrammatically in the second portion 5 of the layer of insulation situated in the plate portion 22 the thickness whereof has been reduced by the rear face etching.

There are also represented diagrammatically the tracks 14 for connecting each of the sensors 6, 8, 10, 12 to two electrical terminals 3 in order to make an electrical connection between each of the sensors 6, 8, 10, 12 and an electronic measurement circuit (not shown).

FIG. 4 also shows the reduced thickness region 22 in which the plate 2 has undergone rear face etching as explained with reference to FIGS. 1 and 2.

Finally, FIG. 4 shows the cutting path 18 formed essentially on the three sides of a rectangle and the hinge 24 produced in the rear face of the plate 2 that terminates the definition of the rectangular shape region intended to be inclined relative to the other portions of the plate 2.

The example that has just been described represents only one possible embodiment of the invention.

Alternatively, there can be provision for inclining an area of a substrate by a method similar to that described hereinabove in order thereafter to stick to the inclined plane obtained in this way one or more active components.

Another alternative, which may be combined with the previous one, is for the reduced thickness portion to be inclined in a direction opposite to that described hereinabove (that is to say upward starting from FIG. 2, and not downward as in FIG. 3). In this context, the etching step could release stresses within the plate that bring about the required inclination of the etched area.

1. A method of producing a component comprising a first face of a plate-shaped structure, the method comprising the following steps:
etching a portion of a second face of the plate-shaped structure, to define a reduced thickness area, wherein the second face is opposite the first face;
forming a hinge over a first portion of the circumference of the reduced thickness; and
inclining the reduced thickness area relative to the plate-shaped structure, wherein the included reduced thickness area comprises a first active element.

2. The method according to claim 1, wherein the first face includes the first active element before the inclining step.

3. The method according to claim 1, wherein the method further comprises attaching the first active element to the inclined reduced thickness area after inclining the reduced thickness area.

4. The method according to claim 3, further comprising a step of gluing the attached first active element.

5. The method according to claim 1, wherein the method further comprises etching a cutting path over a second portion of the circumference of the reduced thickness area before inclining the reduced thickness area.

6. The method according to claim 1, wherein the step of forming a hinge comprises transferring a notch formed on the second face by etching the second face.

7. The method according to claim 1, wherein the first active element comprises magnetic field sensor.

8. The method according to claim 7, wherein the magnetic field sensor comprises a microfluxgate.

9. The method according to claim 1, wherein the method further comprises disposing a second active element on a portion of the plate-shaped structure not subjected to the etching of the second face.

10. The method according to an claim 1, further comprising a step of transferring the plate-shaped structure onto a substrate.

11. The method according to claim 10, wherein the method further comprises contacting the second face of the plate-shaped structure is with the substrate and wherein one end of the reduced thickness area comes into contact with the substrate.

12. A component comprising an area inclined relative to a plate-shaped structure and an active element disposed on a first face of the inclined area, wherein the inclined area has a reduced thickness relative to the plate-shaped structure and is connected to the plate-shaped structure by a hinge and wherein the component includes a recess between the inclined area and the plate-shaped structure.

13. The component according to claim 12, wherein the thickness of a portion of the hinge is less than the reduced thickness of the inclined area.

14. The component according to claim 12, wherein the plate-shaped structure comprises at least one active component on a first face.

15. The component according to claim 12, further comprising a substrate wherein a second face of the plate-shaped structure is fastened to the substrate.

16. The component according to claim 15, wherein an end of the inclined area opposite the plate-shaped structure is in contact with the substrate.

17. The component according to claim 16, further comprising means for holding the inclined area relative to the substrate.

18. The component according to claim 17, wherein the holding means comprises a glue or resin t in the area of contact of the substrate and the inclined area.

19. The component according to claim 17, wherein the holding means comprises electrostatic or magnetic forces.

20. The component according to claim 12, wherein the active element comprises a magnetic field sensor.

21. The component according to claim 20, wherein the magnetic field sensor comprises a microfluxgate.

22. The component according to claim 20, wherein the magnetic field sensor is adapted to measure a magnetic field in a direction parallel to the inclined area and at a non-zero angle with the plate-shaped structure.
